(19) United States
(12) Patent Application Publication
(10) Pub. No.: US 2009/0136634 A1
(43) Pub. Date: May 28, 2009

(54) SEASONED TOFU AND METHOD OF PRODUCING THE SAME

(75) Inventors: Masayoshi Taketsuka, Zama-shi (JP); Masanori Hattori, Konan-shi (JP); Manabu Suzuki, Zama-shi (JP)

Correspondence Address: WOOD, HERRON & EVANS, LLP, 2700 CAREW TOWER, 441 VINE STREET, CINCINNATI, OH, 45202, US

(73) Assignee: MORINAGA MILK INDUSTRY CO., LTD., Tokyo (JP)

(21) Appl. No.: 11/917,518

(22) PCT Filed: Dec. 18, 2006
(86) PCT No.: PCT/JP2006/325209

§ 371 Date: Dec. 14, 2007

(30) Foreign Application Priority Data
Dec. 26, 2005 (JP) 2005-372068

(51) Int. Cl. A23L 1/20

(52) U.S. Cl. 426/271; 426/634

(57) ABSTRACT

It is intended to provide seasoned tofu which has a favorable mouthfeel in “hardness” and “brittleness” and has been evenly seasoned throughout, and a method of producing the same. Seasoned tofu is produced by heating and coagulating seasoned soymilk containing soybean milk, a seasoning providing sodium ion and/or potassium ion and glucono delta-lactone as a coagulant wherein the concentration of soybean protein is 5.5% by mass or more and 8.5% by mass or less, the total concentration of the sodium ion and/or potassium ion is 0.05 mol/L or more and 0.154 mol/L or less and the concentration of the glucono delta-lactone is 0.4% by mass or more and 0.9% by mass or less.

### TECHNICAL FIELD

The present invention relates to seasoned tofu and a method of producing the same seasoned tofu.

This application claims priority on Japanese Patent Application No. 2005-372068 filed on Dec. 26, 2005, the disclosure of which is incorporated by reference herein.

### BACKGROUND OF THE INVENTION

Recent health trends in the diet have been reflected by an interest in soybean products, especially tofu, types of product, and various methods for cooking. This trend has been remarkable in America as well as Japan and the market for soybean products has kept growing, especially, after the FDA approved food labeling of disease prevention effects (health claims) of soybean protein. However, tofu is not very acceptable and developments in the field of tofu are slow because tofu has a particular beany flavor and very bland taste.

Also, the tendency to utilize food ready-to-eat has grown due to busy life styles, but tofu having a traditional quality and taste is not met to this request. In recent years, a product in which tofu is marinated in sauce, a Firm Tofu which is steeped in seasoning liquid and pressed, and the like has been sold. However, tofu which has both a fine texture like Silken Tofu and a feature of seasoning throughout the tofu does not exist.

The following Patent document 1 discloses a method in which soybean milk is coagulated by adding organic acid, metal salt, and salt to the soybean milk, to produce tofu. However, as shown in the following reference Test example 1, tofu including salt produced by the blend and the method disclosed in the Patent document 1 can not obtain sufficient hardness stress and brittleness stress in comparison with marketed Silken Tofu.

Also, the following Patent document 1 discloses “Yushi Tofu” produced by using sea water to coagulate soybean milk in a soybean coagulating method as the traditional method, however, “Yushi Tofu” is insufficiently solidified, soft, amorphous, and so-called “Oboro Tofu” and does not have mouthfeel like Silken Tofu. Also, tofu in which “Yushi Tofu” is coagulated and pressed (in a method for Momen Tofu) is called “Shima Tofu (Okinawa Tofu).” This includes salt and is very solid and, as shown in the following reference Test example 2, the hardness stress is very great, the brittleness stress is small, and the smoothness of the texture is inferior.

The following Patent document 2 discloses a method for producing packed aseptic tofu in which a coagulant solution dissolving coagulant in a salt solution is added to soymilk. However, the final salt concentration of the soymilk to be coagulated is low, 0.05 to 0.2%, and does not provide a sufficient salty taste.

The following Patent document 3 discloses a method for producing packed aseptic Firm Tofu and 1 to 4% of Isolated Soy Protein having a high coagulation property is added to soybean milk in order to produce Firm Tofu by increasing the hardness of the soybean milk. It does not disclose adding a seasoning agent such as salt.

### [Patent Document 1] Japanese Laid-Open Patent Application No. 2000-201641

[Patent Document 2] Japanese Laid-Open Patent Application No. Sho 50-160450
[Patent Document 3] Japanese Laid-Open Patent Application No. Sho 62-195262

### DISCLOSURE OF INVENTION

### Problems to be Solved by the Invention

As described above, seasoned tofu has not been developed which has both of a fine mouthfeel like Silken Tofu and a feature of seasoning throughout a tofu.

The present invention has been made in order to solve the above problems and provides seasoned tofu which has excellent mouthfeel in “hardness” and “brittleness” and is uniformly seasoned throughout and a method for producing the same.

### Means for Solving the Problems

In order to achieve the above object, a method for producing seasoned tofu of the present invention includes a step of heating and coagulating seasoned soymilk having soybean milk, a seasoning providing sodium ion and/or potassium ion, and glucono delta-lactone as a coagulant, in which a concentration of soybean protein is 5.5% by mass or more and 8.5% by mass or less, a total concentration of sodium ion and/or potassium ion is 0.05 mol/L or more and 0.154 mol/L or less, and a concentration of glucono delta-lactone is 0.4% by mass or more and 0.9% by mass or less.

The present invention provides seasoned tofu obtained by heating and coagulating seasoned soymilk having soybean milk, a seasoning providing sodium ion and/or potassium ion, and glucono delta-lactone as a coagulant, in which a concentration of soybean protein is 5.5% by mass or more and 8.5% by mass or less, a total concentration of sodium ion and/or potassium ion is 0.05 mol/L or more and 0.154 mol/L or less, and a concentration of glucono delta-lactone is 0.4% by mass or more and 0.9% by mass or less, the seasoned tofu having the hardness stress of 8,000 [N/m²] or more and brittleness stress of 4,000 [N/m²] or more.

### EFFECTS OF THE INVENTION

The present invention can provide seasoned tofu which has an excellent mouthfeel in “hardness” and “brittleness” and is uniformly seasoned throughout the tofu.

### BEST MODE FOR CARRYING OUT THE INVENTION

There is no limitation on soybean milk used in the present invention and, soybean milk obtained by, as a traditional method, soaking soybeans in water, grinding them to obtain Go (Slurry), and heating and filtrating the slurry may be used. There is no limitation on the raw soybeans and soybeans grown in Japan, America, Canada, or the like can be used. A concentration of soybean protein in the soybean milk is usually about 3.8 to 6.7% by mass.

The seasoning of the present invention is selected from a compound which can be added in order to season food. “Providing sodium ion and/or potassium ion” means sodium ion and/or potassium ion is produced in aqueous solution.

Specific examples include inorganic salts such as sodium chloride or potassium chloride, salts of amino acids such as sodium glutaminate or sodium aspartate, salts of organic acid such as sodium citrate, sodium succinate, or sodium tartrate, and salts of nucleic acid such as sodium inosinate or sodium guanylate.

The present invention uses glucono delta-lactone as a coagulant. Another coagulant other than glucono delta-lactone may be used. Specific examples of another coagulant include magnesium chloride, calcium chloride, calcium sulphate, magnesium sulfate, crude sea sodium chloride, and the like. When using another coagulant, the rate of another coagulant is 30% by mass or less, preferably 10% by mass or less, to the total coagulant used. It is most preferable that 100% by mass of coagulant be glucono delta-lactone

A method for producing seasoned tofu according to an embodiment of the present invention is explained below.

At first, a concentration of soybean protein in soybean milk is increased to obtain raw soymilk. In particular, the concentration of soybean protein is increased so that the concentration of soybean protein of seasoned soymilk which is used in the following step of heating and coagulating is 5.5% by mass or more and 8.5% by mass or less. The concentration of soybean protein of the seasoned soymilk preferably is within a range of from 6.0% by mass to 8.0% by mass.

A method of increasing the concentration of soybean protein of the soybean milk may be (1) a method of adding an isolated soybean protein to soybean milk, (2) a method of concentrating soybean milk, or the combinations thereof.

(1) In the case of adding an isolated soybean protein to soybean milk, there is no particular limitation on the isolated soybean protein, provided that the isolated soybean protein is a protein isolated from a soybean. For example, New Fuji Pro SEH (product name, made by Fuji Oil Co., Ltd.), Profam 974 (product name, made by Daniels Midland Company), Supro760 (product name, made by Solae, LLC.), or the like can be preferably used.

In particular, an isolated soybean protein is added to soybean milk and uniformly dispersed or dissolved by stirring. It is preferable to previously heat soybean milk at 30 to 50° C., because it is easy to disperse or dissolve an isolated soybean protein and is difficult for chunks to be generated.

The amount of an isolated soybean protein added is adjusted so that a concentration of soybean protein of seasoned soymilk to be added in the following step of heating and coagulating is 5.5% by mass or more and 8.5% by mass or less. When the concentration is set to be 5.5% by mass or more, seasoned tofu in which a seasoning is added can obtain the hardness like Silken Tofu and excellent mouthfeel. When the concentration is above 8.5% by mass, it may be remarkably difficult to disperse or dissolve an isolated soybean protein in soybean milk.

(2) In the case of concentrating soybean milk, a method in which a temperature of soybean milk does not increase above 70° C. or more is preferable. For example, a method of using a vacuum evaporator (plate type, batch type, multiple-effect evaporation, or the like) or membrane concentrator (UF (ultrafiltration) film, RO (reverse osmosis pressure) film, NF (Nanofiltration) film, or the like) is preferable.

The level of concentration is adjusted so that a concentration of soybean protein of seasoned soymilk which is used in the following step of heating and coagulating is 5.5% by mass or more and 8.5% by mass or less. When the concentration is set to be 5.5% by mass or more, seasoned tofu in which a seasoning is added can obtain the hardness like Silken Tofu and excellent mouthfeel. When the concentration is above 8.5% by mass, in any above method of concentrating, the viscosity of seasoned soymilk increases and the efficiency of the concentration is remarkable worsened.

Next, the obtained raw soymilk goes through a sterilizing treatment to obtain sterilized soymilk. When adding an isolated soybean protein to soybean milk, it is preferable that raw soymilk be homogenized and the isolated soybean protein be excellently dispersed or dissolved prior to a sterilizing treatment.

There is no particular limitation on a method of sterilizing treatment. For example, a direct heating method, in which raw soymilk and pressurized steam are directly contacted, or an indirect heating method, in which raw soymilk is contacted to a heat medium via a heat exchanger plate surface, may be used. A direct heating method is preferable in terms of reducing damage of a soybean protein by heating.

When sterilizing by a direct heating method, the heating condition is a condition having the same or better effect than obtained by keeping at 120° C. for 4 minutes. Herein, “a condition having the same or better effect than obtained by keeping at 120° C. for 4 minutes” means that sterilizing effects are the same or more than the sterilizing effect obtained by keeping at 120° C. for 4 minutes and, in another words, that the lethal effect after sterilizing is the same or better than the state obtained by keeping at 120° C. for 4 minutes. Therefore, if heating time or heating temperature is different, a condition having the same or better than the sterilizing effect obtained by keeping at 120° C. for 4 minutes can be called “a condition having the same or better effect than obtained by keeping at 120° C. for 4 minutes.”

After a sterilizing treatment, it is preferable to be immediately cooled at from 2 to 25° C. and to be sterilized soymilk.

Next, a seasoning and coagulant are added to the obtained sterilized soymilk to obtain a seasoned soymilk.

Because, when adding a seasoning and coagulant before a heat sterilizing treatment, the thickening or coagulation may occur in the step of heat sterilization treatment to remarkably lower the hardness of tofu to be finally obtained, it is preferable to add them after completing a heat sterilization treatment.

An amount of a seasoning added is adjusted so that the total concentration of a sodium ion and/or potassium ion of a seasoned soymilk which is used in the following step of heating and coagulating is 0.05 mol/L or more and 0.154 mol/L or less. The concentration is preferably within a range of from 0.07 to 0.14 mol/L and more preferably within a range of from 0.10 to 0.12 mol/L.

If the total concentration of a sodium ion and/or potassium ion is 0.05 mol/L or more, the excellent taste of the seasoning is felt when eating tofu. If the total concentration of a sodium ion and/or potassium ion is 0.154 mol/L or less, tofu can obtain excellent hardness.

An amount of a coagulant added is adjusted so that the concentration of glucono delta-lactone of seasoned soymilk which is used in the following step of heating and coagulating is 0.4 to 0.9% by mass. The concentration is more preferably within a range of from 0.5 to 0.8% by mass and further preferably within a range of from 0.6 to 0.7% by mass.

If the concentration of glucono delta-lactone is 0.4% by mass or more, the excellent mouthfeel in “hardness” and “brittleness” of tofu can be obtained. If the concentration of glucono delta-lactone is above 0.9% by mass, the acid taste of the tofu may be strong to impair the texture.

In particular, it is preferable that the coagulant solution in which a seasoning and coagulant are dissolved in water be previously prepared and this coagulant solution be added to sterilized soymilk after sterilizing treatment.

As a method of a sterilizing treatment for the coagulant solution, for example, a microfiltration or the like is preferable.

When an amount of coagulant solution added to sterilized soymilk is too much, the component balance is remarkably affected and, as result, a protein concentration is lowered. Therefore, the amount is preferably 5% by mass or less and more preferably 3% by mass or less to the total amount of the sterilized soymilk and coagulant solution.

Next, seasoned tofu is obtained by heating and coagulating the obtained seasoned soymilk. In particular, the obtained seasoned soymilk fills a suitable package, and is heated and coagulated in the closed state. It is preferable to use a sterilized package and to fill and close the package under an aseptic condition.

Examples of a heating method include a method of immersing in hot water, a method of passing through a steaming heat tank, and the like. A method of immersing in hot water is preferable in that it is easy to provide a uniform temperature in the heat tank.

In order to coagulate sufficiently, the heating temperature of the seasoned soymilk after filling the package is preferably a product temperature of 70° C. or more, and more preferably 80° C. or more. If the heating temperature is too high, the structure is worsened. Therefore, it is preferably 95° C. or less and more preferably 90° C. or less.

The heating time is enough provided that a seasoned soymilk is completely coagulated and can be determined according to the heat temperature. It is not preferable to heat more than need be because the appearance and texture is worsened. Therefore, the heating time depends on the heating temperature and however, in general, is preferably about 10 to 120 minutes and more preferably 20 to 60 minutes.

It is preferable to immediately cool it by ice-cold treatment after heating and coagulating the seasoned soymilk. For cooling, it is preferable that the temperature of the whole tofu be uniform and within a range of from 2 to 25° C.

The seasoned tofu obtained by such a method can obtain excellent taste and be uniformly seasoned throughout the tofu because a seasoning is added in seasoned soymilk which is used in the step of heating and coagulating so as to be the prescribed ion concentration.

In general, there is tendency that when salt is added to soybean milk, the hardness of the tofu of the final product is lower. However, because, in the method of the present invention, the total concentration of sodium ion and/or potassium ion in a seasoned soymilk which is used in the step of heating and coagulating, and the concentration of glucono delta-lactone is controlled within the prescribed range, while a concentration of soybean protein of soybean milk is increased to the prescribed range, the seasoned tofu having excellent mouthfeel in “hardness” and “brittleness” is obtained.

Also, the method of the present invention can add a coagulant, seasoning, and the like by in-line dosing and continuously produce seasoned tofu. Also, the method of the present invention may be applicable to a production line and can obtain an aseptic, seasoned Silken Tofu which can keep at ordinary temperature for a long term.

In the present invention, another food material other than the above seasoning, which is, in other words, food material without sodium ion and/or potassium ion, may be added. In this case, it is preferable to add another food material before the sterilizing step. It is preferable to add another food material when or after preparing the above raw soybean milk, and before the sterilizing step.

Seasoned tofu of the present invention is produced by the method of the present invention and the hardness stress thereof is 8,000 [N/m²] or more, and the brittleness stress thereof is 4,000 [N/m²] or more.

In the present invention, the value of “hardness stress” and “brittleness stress” of the seasoned tofu which is heated and coagulated is measured by using the Rheoner II creep meter RE2-33005S (product name, made by Yamaden incorporation) under the following condition.

load converter sensibility: 20N

plunger: disk type with f 50 mm

speed of compression: 0.5 mm/sec

strain: 90%

shape of sample: cylinder form with f 20 mm×12 mm

temperature of sample: 10° C.

“Hardness stress” measured in this way is a value showing a force needed for straining a tofu. “Brittleness stress” is a value showing a force needed for crushing tofu, i.e., the index of property in which the structure is destroyed by chewing.

According to experimentation by the inventors, “hardness stress” of commercially produced Silken Tofu (10 kinds) is within a range of from 8,000 to 20,000 N/m² and the average thereof is about 12,400 N/m². Also, “brittleness stress” is within a range of from 4,000 to 12,000 N/m² and the average thereof is about 9,000 N/m².

Therefore, when seasoned tofu has the hardness stress of 8,000 N/m² or more and the brittleness stress of 4,000 N/m² or more, seasoned tofu can obtain an excellent mouthfeel like Silken Tofu. In order to obtain an excellent mouthfeel, the preferable range of the hardness stress is within a range of from 8,000 to 35,000 N/m². Also, the preferable range of the brittleness stress is within a range of from 4,000 to 20,000 N/m².

Seasoned tofu of the present invention can be obtained by heating and coagulating seasoned soymilk in which the total concentration of sodium ion and/or potassium ion and the concentration of glucono delta-lactone are within the respective specified range. Because these concentrations are not normally changed after the step of heating and coagulating, seasoned tofu as a final product has the same concentration of soybean protein, the total concentration of sodium ion and/or potassium ion, and the concentration of glucono delta-lactone as the seasoned soymilk.

### EXAMPLES

Specific examples are shown and effects of the present invention are clarified as follows.

### Test Examples 1 to 15

Seasoned soymilk which had a concentration of soybean protein of sodium ion, concentration of potassium ion, and concentration of glucono delta-lactone (occasionally abbreviated as GDL below) shown in Table 1 was prepared.

40 kg of soybean milk (solid content of 10.3% by mass, soybean protein of 4.9% by mass) obtained by the traditional method was heated at about 40° C. and an isolated soybean protein (product name: Supro760, made by Solae, LLC.) was added so that the concentration of soybean protein in the seasoned soymilk was the prescribed value (any of three value of 4.9% by mass, 5.5% by mass, or 8.5% by mass), sufficiently dispersed, and dissolved to obtain raw soymilk.

Next, the obtained raw soymilk was heated to 70° C. and went through a sterilizing treatment by a sterilizer of direct heating (product name: MDU sterilizing machine, made by Morinaga Milk Industry Co., Ltd.) under the heat condition of 149° C. for 2 seconds after homogenizing by a homogenization pressure of 10 MPa. After the sterilizing treatment, it was cooled to 20° C. to obtain sterilized soymilk.

Coagulant aqueous solution which was previously prepared by dissolving glucono delta-lactone (product name: Fuji Gulcon, made by Fuso Chemical Co., Ltd.), and sodium ion or potassium ion in water was added to the above-obtained sterilized soymilk so that the content of coagulant aqueous solution was 3% by mass to the total of the sterilized soymilk and coagulant aqueous solution to obtain seasoned soymilk.

A concentration of GDL, concentration of sodium ion, and concentration of potassium ion in the seasoned soymilk were varied within a range of from 0.3 to 1.0% by mass for the concentration of GDL and within a range of from 0.034 to 0.17 mol/L for the concentration of sodium ion and concentration of potassium ion, as shown in Table 1.

The seasoned soymilk obtained in this way filled the plastic package of 300 ml and the package was closed and immersed in hot water of 90° C. for 40 minutes in order to heat and coagulate the seasoned soymilk. After that, it was sufficiently cooled by cold water to obtain seasoned tofu.

The hardness stress and brittleness stress of the obtained seasoned tofu were measured. The tofu temperature was 10° C. when measuring. Also, a sensory test was conducted in terms of savor (saltiness, acidity) and mouthfeel (hardness, texture, smoothness).

The sensory test was conducted by the following method. Each seasoned tofu obtained by test examples was tasted by 20 panelists (10 males, 10 females) and relatively evaluated in terms of savor (saltiness, acidity) and mouthfeel (hardness, texture, smoothness).

Each item was evaluated on 5 scales of −2 to 2 point (2 points: Excellent, 1 point: Good, 0 point: normal, −1: Fair, −2 points: Poor) and the total score for each item was calculated to obtain an average point value. T-assay was used for determining the significant difference and it was determined to differ by 5% risk which is a significant difference. These results are shown in Table 1.

TABLE 1

| | Test Example No. | | | | | | | |
|---|---|---|---|---|---|---|---|---|
| | 1 | 2 | 3 | 4 | 5 | 6 | 7 | 8 |
| Concentration of soybean protein | 5.5 | 5.5 | 5.5 | 5.5 | 5.5 | 5.5 | 5.5 | 5.5 |
| (% by mass) | | | | | | | | |
| Concentration of sodium ion | 0.05 | 0.05 | 0 | 0.05 | 0.05 | 0.154 | 0.17 | 0.034 |
| (mol/L) | | | | | | | | |
| Concentration of potassium ion | 0 | 0 | 0.05 | 0 | 0 | 0 | 0 | 0 |
| (mol/L) | | | | | | | | |
| Concentration of GDL | 0.4 | 0.9 | 0.9 | 0.3 | 1 | 0.4 | 0.4 | 0.4 |
| (% by mass) | | | | | | | | |
| Hardness stress (N/m²) | 10500 | 14400 | 15000 | 6850 | 12200 | 8580 | 7860 | 12240 |
| Brittleness stress (N/m²) | 5995 | 8960 | 9000 | 3840 | 9100 | 4800 | 4500 | 6100 |
| Saltiness strength | 1.3 | 1.3 | 1.3 | 1.3 | 1.3 | 1.7 | 1.9 | −1.6 |
| Acidity strength | 1.7 | 1.0 | 1.0 | 1.7 | −1.6 | 1.7 | 1.7 | 1.7 |
| Hardness (mouthfeel) | 1.1 | 1.3 | 1.3 | −1.6 | 1.3 | 1.3 | −1.0 | 1.3 |
| Texture/Smoothness | 0.7 | 1.3 | 1.3 | −0.5 | 1.3 | 0.7 | 0.7 | 1.0 |

| | Test Example No. | | | | | | |
|---|---|---|---|---|---|---|---|
| | 9 | 10 | 11 | 12 | 13 | 14 | 15 |
| Concentration of soybean protein | 8.5 | 8.5 | 8.5 | 8.5 | 8.5 | 8.5 | 4.9 |
| (% by mass) | | | | | | | |
| Concentration of sodium ion | 0.05 | 0.05 | 0.05 | 0.154 | 0 | 0.034 | 0.05 |
| (mol/L) | | | | | | | |
| Concentration of potassium ion | 0 | 0 | 0 | 0 | 0.154 | 0 | 0 |
| (mol/L) | | | | | | | |
| Concentration of GDL | 0.4 | 0.9 | 1 | 0.4 | 0.4 | 0.4 | 0.4 |
| (% by mass) | | | | | | | |
| Hardness stress (N/m²) | 23660 | 28330 | 33410 | 17060 | 17200 | 24560 | 7000 |
| Brittleness stress (N/m²) | 12560 | 15380 | 18280 | 7950 | 8000 | 13550 | 4000 |
| Saltiness strength | 1.3 | 1.3 | 1.3 | 1.7 | 1.7 | −1.6 | 1.3 |
| Acidity strength | 1.7 | 1.0 | −1.6 | 1.7 | 1.7 | 1.7 | 1.7 |
| Hardness (mouthfeel) | 1.3 | 1.6 | 1.8 | 1.3 | 1.3 | 1.6 | −1.6 |
| Texture/Smoothness | 1.6 | 1.6 | 1.7 | 1.3 | 1.3 | 1.6 | 0.5 |

As results of Table 1, Test examples 1-3, 6, 9, 10, 12, and 13, in which a concentration of soybean protein of sodium ion, concentration of potassium ion, and concentration of GDL in the seasoned soymilk were within a range of the present invention, can provide the excellent hardness stress, excellent brittleness stress, excellent savor (saltiness, acid taste), and mouthfeel (hardness, texture, smoothness).

In contrast, the saltiness of Test examples 8 and 14, in which a concentration of sodium ion and concentration of potassium ion were low, was insufficient. The hardness of Test example 7, in which a concentration of sodium ion was high, was insufficient.

Also, the hardness and brittleness of Test example 4, in which a concentration of GDL was low, was insufficient and the acid taste of Test examples 5 and 11, in which a concentration of GDL was high, was stronger. The hardness of Test example 15, in which a concentration of soybean protein was low, was insufficient.

### Reference Test Example 1

Tofu having an organic acid, metal salt, and salt was produced according to the specification of the above Patent document 1. In other words, an organic acid (glucono delta-lactone: 0.3% by mass), metal salt (magnesium chloride: 0.01% by mass), and salt (1% by mass) were added to soybean milk (solid content: 10.6% by mass, protein: 4.9% by mass) of 30° C. to prepare tofu.

The hardness stress and brittleness stress of the obtained tofu were measured. The results are shown in the following Table 2. Both of the hardness stress and brittleness stress were insufficient.

To an element in which an amount of the element is not described in the Patent document 1, the general compounding disclosed in the following documents was adopted.

Solid content of soybean: 10.6%, protein: 4.9% (, and salt 0%) described in the latest food standard composition table.

Glucono delta-lactone: 0.2 to 0.3% described in “Soybean Food” (written by Watanabe Tokuji, published by Korin Haakou), and “Easy Science for Tofu” (written by Watanabe Tokuji, published by Food Journal. Co., ltd).

### Reference Test Example 2

The hardness stress and brittleness stress of the commercially produced Okinawa Tofu (Shima Tofu) having salt were measured. The results are shown in the following Table 2. The hardness stress was extremely great and the brittleness stress was extremely small.

The result of Test example 10, in which the hardness stress was highest among the above test examples relating to the present invention, is also shown in Table 2.

The composition of Okinawa Tofu has a solid content of soybean of 18.2%, protein of 9.1%, and salt of 0.4% according to the latest food standard composition table.

TABLE 2

| | Tofu relating to | Okinawa | Test |
|---|---|---|---|
| | Patent document 1 | Tofu | Example 10 |
| Hardness stress (N/m²) | 4500 | 49550 | 28330 |
| Brittleness stress (N/m²) | 2560 | 980 | 15380 |
| Savor (saltiness) | | 1.3 | 1.3 |
| Hardness (mouthfeel) | | 1.8 | 1.6 |
| Texture/Smoothness | | 0.6 | 1.6 |

### Example 1

75 kg of soybean milk (solid content of 10.3%) obtained by the traditional method was heated at about 40° C., an isolated soybean protein was added so that a concentration of soybean protein in the seasoned soymilk was 7% by mass, sufficiently dispersed, and dissolved, and water of about 18 kg was added and mixed to obtain raw soymilk.

Next, the obtained raw soymilk was heated at 70° C. for 10 minutes and went through a sterilizing treatment by a sterilizer of direct heating (product name: Uperisation machine, made by APV) under the heat condition of 149° C. for 2 seconds after homogenizing under the homogenization pressure of 10 MPa. After the sterilizing treatment, it was immediately cooled to 20° C. to obtain sterilized soymilk.

Aside from this, coagulant solution in which GDL and sodium chloride were dissolved in water was prepared (so as to adjust a concentration of GDL of 0.5% by mass and concentration of sodium ion of 0.1 mol/L in the seasoned soymilk) and sterilized by a microfiltration membrane (product name: Millipore filter, made by Millipore Japan Co., Ltd.)

This sterilized coagulant solution was added to the above-obtained sterilized soymilk so as to have the content of 3% by mass and uniformly mixed to obtain seasoned soymilk.

The obtained seasoned soymilk aseptically filled a package of 300 ml by an Aseptic filler machine (product name: Aseptic Brik filler machine, made by Tetra Pack K. K.,), and the package was closed, immersed in a hot water tank at 90° C. for 40 minutes in order to heat and coagulate the seasoned soymilk. After that, the package was cooled. 200 packages filled with an aseptic seasoned tofu were obtained.

The obtained, seasoned tofu was tofu having saltiness, and had the hardness stress of 15,200 [N/m²], and the brittleness stress of 8,100 [N/m²]. The temperature of the tofu was 10° C. when measuring (the following temperature was the same). After keeping the tofu at room temperature for 10 months, it also had excellent savor.

### Example 2

75 kg (solid content of 10.3% by mass) of soybean milk obtained by the traditional method was heated at about 40° C., an isolated soybean protein was added so that a concentration of a soybean protein of seasoned soymilk was 8.5% by mass, sufficiently dispersed and dissolved, and sugar, spice, flavor, and water (the total was about 17 kg) were mixed thereto and dissolved.

Next, after heating at 70° C. for 10 minutes and homogenizing under the homogenization pressure of 10 Mpa, a sterilizing treatment was conducted under the condition of 149° C. for 2 seconds by using a sterilizer of direct heating (product name: MDU sterilizing machines made by Morinaga Milk Industry Co., Ltd). After that, it was immediately cooled down to 20° C. to obtain sterilized soymilk.

Aside from this, coagulant solution was prepared by dissolving GDL, sodium chloride, and sodium glutaminate in water (the concentration of GDL is 0.6% by mass in the seasoned soymilk, the concentration of sodium ion derived from sodium chloride is 0.05 mol/L, the concentration of sodium ion derived from sodium glutaminate is 0.05 mol/L) and sterilized as Example 1.

This sterilized coagulant solution was added so as to have the content of 3% by mass to the above-obtained sterilized soymilk and homogeneously mixed to obtain seasoned soymilk.

The obtained seasoned soymilk aseptically filled a package of 300 ml by an Aseptic filler machine as Example 1 and the package was closed and past through a steaming heat tank (product name: lift steamer, made by Asahi Industry Co., Ltd) of 90° C. for 40 minutes in order to heat and coagulate the seasoned soymilk. After that, the package was cooled down to 25° C. 200 packages filled with aseptic seasoned tofu were obtained.

The obtained seasoned tofu was tofu having rich smell of spice, saltiness, and delicious taste and had the hardness stress of 16,300 [N/m²] and brittleness stress of 7,700 [N/m²]. After keeping the seasoned tofu at room temperature for 10 months, a savor was excellent.

### Example 3

Soybean milk (solid content of 10.3% by mass, soybean protein of 4.9% by mass) obtained by the traditional method was cycle-concentrated by a centrifugal thin film vacuum evaporator (made by Okawara MFG. CO., LTD) to obtain concentrated soybean milk having a solid content of 15% by mass and a concentration of soybean protein of 7.5% by mass.

After conducting a sterilizing treatment using the same sterilizer of direct heating as Example 2 under the condition of 149° C. for 2 seconds, the concentrated soybean milk was cooled to concentrated soybean milk.

Aside from this, coagulant solution was prepared by dissolving GDL and potassium chloride in water (so that the concentration of GDL is 0.4% by mass in the seasoned soymilk, the concentration of potassium ion is 0.05 mol/L) and sterilized as Example 1.

This sterilized coagulant solution was added so as to have the content of 3% by mass to the above-obtained sterilized soymilk and homogeneously mixed to obtain seasoned soymilk. The concentration of soybean protein in the seasoned soymilk was about 7.3% by mass.

The obtained seasoned soymilk aseptically filled a package of 300 ml by the same aseptic filler machine as Example 1, the package was closed, and the seasoned soymilk was heated and coagulated as Example 2. After that, the package was cooled down to 25° C. 200 packages filled with aseptic seasoned tofu were obtained.

The tofu obtained in this way was tofu having proper saltiness and had the hardness stress of 21,000 [N/m²] and brittleness stress of 11,000 [N/m²]. After keeping the tofu at room temperature for 10 months, savor was excellent.

### INDUSTRIAL APPLICABILITY

The present invention provides seasoned tofu which has an excellent mouthfeel in “hardness” and “brittleness” and is uniformly seasoned throughout.

1. A method of producing seasoned tofu, comprising:
a step of heating and coagulating seasoned soymilk which has soybean milk, a seasoning providing a sodium ion and/or potassium ion, and a glucono delta-lactone as coagulant, wherein
a concentration of a soybean protein is 5.5% by mass or more and 8.5% by mass or less,
the total concentration of the sodium ion and/or potassium ion is 0.05 mol/L or more and 0.154 mol/L or less, and
a concentration of the glucono delta-lactone is 0.4% by mass or more and 0.9% by mass or less.

2. A method for producing seasoned tofu according to claim 1, wherein the step of heating and coagulating seasoned soymilk comprises:
a step of obtaining raw soymilk by increasing the concentration of the soybean protein in the soybean milk;
a step of obtaining sterilized soymilk by sterilizing the raw soymilk; and
a step of adding the seasoning providing the sodium ion and/or potassium ion and the glucono delta-lactone as coagulant in the sterilized soymilk.

3. A method for producing seasoned tofu according to claim 2, wherein the step of obtaining the raw soymilk comprises:
a step of adding an isolated soybean protein to the soybean milk; and/or
a step of concentrating the soybean milk.

4. A method for producing seasoned tofu according to any of claims 1 to 3, wherein the obtained seasoned tofu has a hardness stress of 8,000 [N/m²] or more and a brittleness stress of 4,000 [N/m²] or more.

5. Seasoned tofu, obtained by heating and coagulating seasoned soymilk which comprises soybean milk, a seasoning providing a sodium ion and/or potassium ion, and a glucono delta-lactone as coagulant, and has a concentration of soybean protein of 5.5% by mass or more and 8.5% by mass or less, the total concentration of the sodium ion and/or potassium ion is 0.05 mol/L or more and 0.154 mol/L or less, and a concentration of the glucono delta-lactone is 0.4% by mass or more and 0.9% by mass or less; wherein
a hardness stress is 8,000 [N/m²] or more and a brittleness stress is 4,000 [N/m²] or more.
